(19) United States
(12) Patent Application Publication
(10) Pub. No.: US 2015/0122739 A1
(43) Pub. Date: May 7, 2015

(54) DEVICE AND METHOD FOR SEPARATING GRINDING OIL FROM GRINDING SLURRIES

(71) Applicant: ERWIN JUNKER GRINDING TECHNOLOGY A.S., Melnik (CZ)

(72) Inventors: Georg Himmelsbach, Haslach (DE); Günter Abendschein, Biberach (DE)

(21) Appl. No.: 14/406,578

(22) PCT Filed: Jun. 11, 2013
(86) PCT No.: PCT/EP2013/061997

§ 371 Date: Dec. 9, 2014

(30) Foreign Application Priority Data
Jun. 12, 2012 (DE) 10 2012 209 818.6

(51) Int. Cl. B24B 57/00; B01D 21/28; B01D 21/00

(52) U.S. Cl. CPC B24B 57/00; B01D 21/0042; B01D 21/286; B01D 2021/0078
USPC 210/696; 210/522

(57) ABSTRACT

An apparatus has a stirred tank with a stirrer movable upwards and downwards. Oil-containing grinding sludge is introduced into the stirred tank by a supply conduit. Separating agent is introduced into the stirred tank for separating the grinding oil from the grinding sludge. The sludge is discharged into a receiving tank via a discharge conduit. In the stirred tank, a movable annular plate is guided to form a seal on a stirrer guide tube and/or on the inner face of the wall of the tank. The plate has a passage for discharging the grinding oil. A discharge conduit for the de-oiled grinding sludge is at the lowest point of the tank. The stirrer achieves a homogeneous mixture of separating agent and grinding sludge, so that the grinding oil can be separated from grinding particles of the sludge. The grinding oil can then float and be removed.

This is the U.S. National Stage of International Patent Application No. PCT/EP2013/061997, which has an international filing date of Jun. 11, 2013, and claims the priority benefit of German patent application no. 10 2012 209 818.6, filed Jun. 12, 2012. The entire contents of each of the foregoing are incorporated herein by reference.

### FIELD OF THE DISCLOSURE

The present disclosure relates to an apparatus and a method for separating grinding oil from grinding sludges.

### BACKGROUND

On current grinding machines grinding oil is frequently employed in the grinding process. The removed grinding particles together with the grinding oil form grinding sludge. On the one hand the grinding sludge constitutes hazardous waste and can therefore only be disposed of at relatively high costs. On the other hand it makes sense to separate the grinding oil from the grinding sludge, in order not only to return this grinding oil to the grinding process for reasons of cost, but also the grinding particles constitute valuable raw material which in the case of metal can be melted down again. However, this latter is only possible if the grinding oil is separated out as thoroughly as possible from the grinding sludge.

Arising out of this necessity, methods and apparatuses are already known for separating grinding oil out of grinding sludges. DE 10 2009 054 076 A1 describes a method for separating grinding oil out of grinding sludges and a separating station for carrying out the method. The basis for the method and the functioning of the separating station is the use of an inductor plate which serves as a heating system and on which the grinding sludge is spread out. To this end the induction heat heats the ferromagnetic steel or iron particles contained in the grinding sludge, which leads to a reduction in the viscosity of the grinding oil contained in the grinding sludge. Because of the reduced viscosity the heated grinding oil can run off through holes in a perforated plate. The method and the apparatus have proved to function well, but nevertheless the proportion of grinding oil remaining in the grinding sludge is still unsatisfactorily high after removal of the grinding oil. The higher the proportion of grinding oil is which can be recovered, the more economical the entire method is. However, even if relatively small residual amounts of grinding oil are present in the grinding sludge, this leads to the grinding sludge being regarded as hazardous waste. Therefore the known method provides for the residual amount of grinding oil to be burned. Although this means that the grinding particles can be returned to the raw materials cycle, it does necessitate an additional plant for the burning, which moreover with regard to the relatively high costs of the grinding oil is regarded as uneconomical, and reduces the quantity of grinding oil which can be recovered.

Because of the known difficulties of separating oil from the grinding sludge reliably and in a sufficient quantity, the processing method according to EP 1 030 755 B1 is completely different. In order to eliminate these disposal problems in the clearance of grinding sludge, the processing by grinding is omitted completely. This is based on the idea that the separation of oil from chips which are significantly larger in size coming from the processing is unproblematic because of the much smaller specific surface area of the chips by comparison with grinding dust.

DE 198 39 846 B4 describes a centrifuge by means of which grinding sludge is deoiled. The centrifuging process is based on the density difference between the grinding oil and the grinding particles. In principle by means of such a centrifuging process significant proportions of grinding oil are removed from the grinding sludge and the dried grinding sludge can be extracted from the centrifuge, but because of the sometimes very small size of the grinding particles either these are discharged together with the grinding oil or unacceptably large proportions of grinding oil remain in the grinding sludge. In order to avoid the deoiled grinding sludge nevertheless having to be disposed of as waste, such a centrifuging process may only be useful to some extent.

A different way is employed in a known method with a known apparatus according to DE 195 32 802 C1. This method and this apparatus relate to the utilization of grinding sludges. In this case a separation of metallic and mineral grinding chips and grinding agent residues from grinding oil takes place, wherein the organic matter contained in this mixture is anaerobically biodegraded. To this end the heated grinding sludge is admixed with digested sludge and is treated anaerobically in a heated biogas reactor. In this biodegradation process biogas is produced. The resulting digested sludge, after leaving the biogas reactor, is subjected to a solid-liquid separation in a sedimentation tank, wherein this is followed by a further stage in a hydrocylone in which a solid-solid separation takes place. A disadvantage of this method is inter alia that the relatively expensive grinding oil is degraded but is not recovered.

DE 42 24 953 C1 describes a method for refurbishing oil-contaminated industrial sludges. In the attempt to remove the oil present in the industrial sludges as thoroughly as possible, the oil components of the sludges are extracted from the sludges with low-boiling hydrocarbons as solvents. Then the solvent residues in the deoiled solvent are stripped out by steam. Low-boiling hydrocarbons are used as solvents. With this method, the oil content of such oil-contaminated industrial sludges is reduced to approximately 0.3%, but because of the mixing with the low-boiling hydrocarbons the oil which is separated out cannot be reused without costly treatment. Thus in the case of grinding sludges only one aspect is solved, namely the delivery of the grinding particles, largely freed of oil, to a smelting process, without the grinding particles having to be disposed of as hazardous waste. At all events a reprocessing of the oil-laden solvent takes place in an ancillary used oil recycling plant. In addition the residual solvent adhering to the grinding particles must be stripped out with saturated steam, which leads to an additional purification process, namely the removal of the solvent from the saturated steam. This results overall in high apparatus costs.

Finally, EP 0 515 011 A2 discloses a method for purifying metallic grinding sludges of oil or oil-containing emulsions. The basis for the method is that the oil-containing grinding sludge is pressed out in a first method step. The oil which is expressed out is delivered to a used oil disposal facility, that is to say it is not intended to deliver this relatively expensive grinding oil to be reused. Then the discharged sludge must be comminuted and must be vortexed and washed with active washing substances in a cleaning fluid whilst being simultaneously heated to a temperature >50° C. In order to achieve a reasonably effective separation, the washing process must take place in at least three batches, wherein after each batch the cleaning fluid must be drained off and replaced by fresh cleaning fluid. After the washing the sludge must be dewatered and rinsed by means of warm fresh water at 40° C. The rinsing process must also take place in at least three batches, wherein after each batch the rinsing water must be drained off and replaced by fresh rinsing water. In order that the rinsing water entrains the smallest possible amount of metallic grinding particles, it must be passed over a magnetic separator. The rinsed sludge must then be dried and can be compacted by additional pressing. Optionally the cleaning fluid as well as the rinsing water are treated after corresponding chemical cleavage and are separated from the residual oil. This method necessitates relatively high apparatus costs. The method only aims to deliver a grinding sludge which is still contaminated with as little oil as possible to a remelting process. Reuse of the grinding oil is not possible, so that the oil which is separated off is to be delivered to a used oil disposal facility. Thus, above all because of the relatively high costs of the grinding oil, the economic efficiency of the method is not provided to a sufficient extent, even if the proportion of residual oil in the dry sludge is optionally less than one percent by weight.

### General Description of the Disclosure

An object of the disclosure therefore is to provide an apparatus and a method for separating off grinding oil from grinding sludges, which with low apparatus costs ensures a high degree of separation of grinding oil from the grinding sludges in such a way that the grinding sludges do not have to be disposed of as hazardous waste and can be delivered to a remelting process as a recyclable material, and on the other hand the grinding oil can be reused in the grinding.

According to the disclosure, the apparatus for separating off grinding oil from grinding sludge admixed with this grinding oil has a stirred tank in which a stirrer guided in a stirrer guide tube is mounted and is movable upwards and downwards in the stirred tank. The stirrer serves so that oil-containing grinding sludge which is introduced into the tank via a first supply conduit disposed in the upper region of the stirred tank is stirred together with a separating agent located or likewise introduced into the stirred tank. In the lower region of the stirred tank are provided both a supply and discharge conduit for the separating agent for separating off the grinding oil from the grinding sludge and also a discharge conduit for de-oiled grinding sludge.

When the grinding sludge is introduced into the stirred tank, this tank preferably already contains a certain quantity of separating agent, so that the grinding sludge cannot clump together on the stirrer or damage the stirrer. Additionally with this grinding sludge a further separating agent is delivered, which in its basic composition constitutes an aqueous solution which contains surfactants and optionally also phosphates, the object of which is to reduce the surface tension of the grinding oil adhering to the individual grinding particles of the grinding sludge so that the grinding oil can be separated, in particular substantially completely, from the grinding particles of the grinding sludge.

The supply and discharge conduit for the separating agent is disposed in the lower region of the stirred tank. Before oil-containing grinding sludge is introduced into the stirred tank, a certain quantity separating agent is preferably already present in the stirred tank, i.e. has been previously introduced. In addition to the oil-containing grinding sludge, the further separating agent is delivered by means of the supply and discharge conduit. Since the separating agent remains physically active for a plurality of stirring cycles of the stirrer, it is also only occasionally necessary for the separating agent located in the stirred container to be replaced, i.e. discharged from the stirred container, and even then only a certain proportion has to be replaced. This is in fact the proportion or the quantity of separating agent which is consumed with regard to its effect of releasing the oil from the grinding particles. Therefore this consumed separating agent can be discharged from the stirred tank via the common supply and discharge conduit. In this case will the separating agent is conveyed out of the stirred tank into the separating agent tank. At least a proportion of the separating agent can be emptied from this separating agent tank, through a valve located on the base thereof, via a pipe leading off from the separating agent tank, and then or simultaneously the separating agent tank is refilled with new separating agent. If all of the separating agent has been consumed, of course the separating agent tank can also be completely emptied and thereafter refilled with completely new separating agent. If only some of the separating agent is replaced, then all of the separating agent present in the separating agent tank again has a higher proportion of unconsumed separating agent, so that when the separating agent is delivered from the separating agent tank to the cleansing process the separating agent can again actively effect the separation of the grinding oil from the grinding sludge.

A certain proportion of the separating agent is also always removed with the grinding sludge discharge. Apart from this so-called depletion of separating agent, based on the entire cleansing process, separating agent is not lost. A separating screen which facilitates the separation out of separating agent discharged with the grinding sludge is provided in the grinding sludge tank. Thus, however, understandably a 100% separating off of the separating agent from the grinding sludge is not achieved.

As after each cycle of discharging grinding sludge this loss of separating agent is made up again, the quantity of separating agent within the stirred tank remains substantially constant.

In a normal cleansing sequence only consumed separating agent as well as the so-called depletion is made up again. In principle, however, it is also possible to completely replace the separating agent after one pass or preferably after a plurality of passes. The replacement or the corrective delivery of separating agent to the stirred tank is defined by the quantity of grinding oil in the grinding sludge, the material properties of the grinding sludge and also cost considerations.

Oil-containing grinding sludge and separating agent are mixed together uniformly, i.e. substantially homogeneously, by the stirrer, so that as far as possible the separating agent reaches every individual grinding sludge particle. On the other hand the stirrer is only operated at such a speed and the separating agent has such a characteristic that the grinding oil contained in the grinding sludge and cleansed thereof does not form an emulsion with the separating agent.

After the stoppage of the stirrer the grinding oil, the grinding sludge and essentially the separating agent are separated.

Since the cleansed grinding oil has a lower density than the separating agent, the grinding oil cleansed of the grinding particles rises upwards in the stirred tank and floats on the separating agent. If sufficiently de-oiled grinding sludge collects in the lower region of the stirred tank, then it can be discharged from the stirred tank by means of the discharge conduit disposed in the lower region. Since with the separating agent used and the apparatus according to the disclosure only a very small residual oil content remains in the grinding sludge, the grinding sludge, i.e. the grinding particles, can be delivered to a smelting process. This avoids the situation where the grinding sludge, which would otherwise be disposed of as hazardous waste, can only be disposed of at great expense. According to the disclosure an annular plate which moves upwards and downwards in the stirred tank is disposed in the stirred tank between a region above a delivery opening of the supply conduit for the oil-containing grinding sludge and a region above the supply and discharge conduit for the separating agent.

According to the disclosure this annular plate slides on an outer face of the stirrer guide tube facing the inner chamber of the stirred tank facing and on the inner face of the stirred tank as it moves upwards and downwards in a sealing manner, for example in the manner of an annular spring as in a coffee maker. In this way the grinding oil cleansed by the separating agent and floating on the latter cannot enter a region in the stirred tank above the annular plate. The annular plate has a passage for the grinding oil on which a discharge conduit for the grinding oil is provided. The grinding oil is reliably and properly separated from the grinding sludge with the aid of the separating agent in such a way that the grinding oil can be supplied for reuse for grinding without separate intensive reprocessing. In principle, the stirrer can be operated in a first mode of operation in which the oil-containing grinding sludge is mixed with the separating agent by stirring, and in a second mode of operation in which the stirrer remains at a standstill. After an appropriate stoppage time the grinding oil settles on the separating agent with a clear boundary layer or separating layer, so that it is readily possible to discharge it from the stirred tank by means of the discharge conduit without separating agent being entrained. Also grinding sludge is not entrained, since because of its greater density it settles in the lower region of the stirred tank.

A substantial advantage of the apparatus according to the disclosure is that by means of one single cleaning container a high degree of cleansing of grinding oil from the grinding particles of the grinding sludge can be achieved, without numerous individual complexes or components or assemblies of this apparatus would have to be provided in which in each case separate functions are performed, as is the case in the prior art. The annular plate is preferably inclined upwards in the direction of the stirrer guide tube, i.e. the outer face of this stirrer guide tube, which faces the interior of the stirred tank, wherein the discharge conduit for the grinding oil is disposed at the highest point of the annular plate. In this case the “highest point” is regarded as the part of the annular plate which because of its inclination points towards the upper face of the stirred tank and is disposed immediately adjacent to the outer face of the stirrer guide tube. This is close to the sealing point of the stirrer plate on the stirrer guide tube. The annular plate is preferably movable upwards and downwards with respect to the height of the stirred tank. Depending upon the filling level and the function to be performed following for example the discharge of grinding sludge or discharge of grinding oil the annular plate covers the mixture of separating agent and grinding sludge or the grinding sludge.

The stirrer is preferably speed-controlled and also can be moved upwards and downwards in the stirred tank. In so far as a movement in the direction of the annular plate is concerned, this upward movement of the stirrer on the one hand and the corresponding downward movement of the annular plate are controlled so that that the movement does not fall short of a preselected minimum distance between the annular plate and the stirrer. This is preferably achieved by means of sensors which monitor, preferably permanently, the distance between the annular plate and the stirrer during the vertical movements thereof in the stirred tank.

The stirrer is preferably set in rotation in a controlled and driven manner in such a way that the grinding oil separated from the grinding sludge by means of the separating agent is not emulsified with the separating agent, and the duration of the stoppage in the context of the second mode of operation of the stirrer is such that the grinding oil separated out of the grinding sludge floats on the separating agent with a clearly formed separating surface, so that it can be supplied again to the grinding process for reuse without contamination by separating agent after it is removed from the stirred tank. As a result the relatively high cost factor relating to the use of grinding oil in the grinding is minimized, and a negative effect on the environment is substantially avoided. The floating of the grinding oil on the separating agent results on the one hand from the fact that the density of the grinding oil is lower than that of the separating agent, and also derives from the fact that because of the clear difference in the surface tensions the grinding oil is not emulsified with the separating agent.

In order to achieve the most homogeneous possible mixture of grinding sludge and separating agent without the separated grinding oil being emulsified with the separating agent, the stirrer is preferably speed-controlled, in particular in a continuously variable manner, in order to carry out the stirring process, i.e. to achieve a homogeneous mixture of grinding sludge and separating agent, as smoothly as possible, and moreover is driven so as to be reversible in its direction of rotation.

While the stirrer rotates in its first mode of operation in the stirred tank, the stirrer is preferably moved simultaneously upwards and downwards in the stirred tank.

In the discharge conduit sensors are preferably provided for detecting the viscosity of the fluid drained off therein, and supply a signal when separating agent enters the discharge conduit, and then on the basis of the signal a valve in the discharge conduit is closed. This is necessary so that the recovered grinding oil is not mixed with separating agent.

The apparatus according to the disclosure is of modular construction, so that depending upon the desired throughput quantities a plant can have a plurality of such stirred tanks, wherein all of the stirred tanks can be connected to an external tank for separating agent and on the other hand an external tank can be connected for de-oiled grinding sludge. However, the possibility also exists of assigning to every stirred tank a tank for separating agent and/or a respective grinding sludge tank. For reasons of cost, however, generally a plurality of stirred tanks are connected to a tank for separating agent and a grinding sludge tank.

According to a second aspect of the disclosure, the method according to the disclosure for separating off grinding oil from grinding sludge having grinding particles has the steps set out below, wherein the method constitutes an at least virtuously continuous grinding sludge separation method.

In a first step a predetermined amount of separating agent, which serves to reduce the surface tension of the grinding oil on the grinding particles, is introduced into a stirred tank in which a rotatably mounted stirrer is disposed. The quantity of separating agent which is fed into the stirred tank before grinding sludge is delivered thereto depends principally upon the quantity of grinding oil in the grinding sludge and upon the type of grinding oil and also for example upon the type of abraded particulate material contained in the grinding sludge. In a second step grinding sludge containing grinding oil is delivered to the stirred tank together with further separating agent, which takes place while the stirrer is rotating in the stirred tank. The delivery of further separating agent with the grinding sludge does not necessarily have to take place continuously. By the rotation of the stirrer a homogeneous mixture of grinding sludge and separating agent is produced. The stirrer operates in the stirred tank until it is ensured that as far as possible the separating agent reaches all the grinding particles of the grinding sludge, so that as far as possible all of the grinding oil adhering to the grinding particles can be separated therefrom. After production of this substantially homogeneous mixture the stirrer is stopped preferably for several minutes, in particular 5 to 10 minutes. Since the separating agent is constructed in such a way and the rotational speed of the stirrer has such a value that the grinding oil which is separated off is not emulsified with the separating agent, the grinding oil floats on the separating agent, this process proceeding relatively quickly. Furthermore, because of the different surface tensions a clear separating surface forms between the separating agent and the grinding oil, which ensures that in the subsequent step the grinding oil can be discharged from the stirred tank just as the de-oiled grinding sludge can be discharged.

The method according to the disclosure is characterized by a high ecological value because on the one hand the grinding oil can be returned to the grinding process, i.e. unlike the prior art it does not have to be disposed of as waste oil, and that on the other hand the grinding sludge is freed from the grinding oil such that any minor amounts of residual oil present are in any case so small that the grinding sludge is not hazardous waste and can again be delivered directly to a smelting process.

Preferably in the method consumed separating agent in the stirred tank is discharged and a quantity fresh separating agent corresponding to the discharged quantity is returned to the stirred tank. In addition the depletion of separating agent when the grinding sludge is discharged is compensated for by delivery of an amount of separating agent corresponding to the depletion. In principle the separating agent is used for a plurality of cycles of stirring and settling or floating of the grinding oil on the separating agent without significant loss of the action of the separating agent to reduce surface tension. However, after relatively long use the time during which the stirrer rotates will lengthen, so that even if a little separating agent has been consumed it can nevertheless be ensured that the separating agent reaches every grinding particle of the grinding sludge more or less directly and the action to reduce surface tension is nevertheless sufficiently provided.

Preferably the amount of consumed separating agent discharged from the stirred tank is simultaneously added to the amount of further separating agent delivered to the stirred tank together with the grinding sludge, in order ultimately to keep the separating agent/grinding sludge ratio in the stirred tank approximately at a constant level.

Preferably an annular plate covering the mixture of grinding sludge and separating agent is provided in the stirred tank and is moved in a controlled manner in co-ordination with the stirrer in the vertical direction of the stirred tank. During the stirring the annular plate is disposed at a distance above the mixture of grinding sludge and separating agent, because during the stirring the annular plate would be disruptive due to the quite turbulent conditions. Moreover, during stirring the stirrer will preferably move upwards and downwards in the stirred tank. In this case the annular plate and the stirrer are moved in a controlled manner in the vertical direction so that there is always a predetermined minimum distance between the annular plate and the stirrer. When the stirring process is completed and the stirrer has been stopped and the grinding oil is floating on the separating agent, the annular plate is moved to the upper level of the grinding oil substantially without an empty space. When grinding oil is conveyed out of the stirred tank the annular plate is moved further to the respective level of the grinding oil until substantially all of the grinding oil has been conveyed out of the stirred tank. If the stirring process is to be repeated, in this case the annular plate is again moved upwards in the stirred tank so that above the mixture of grinding sludge and separating agent a hollow space which is necessary for the purpose of stirring is formed.

Preferably the de-oiled grinding sludge discharged from the stirred tank is subsequently dried thermally or mechanically, wherein preferably the mechanical drying takes place by pressing. This drying has the advantage that any separating agent present in the grinding sludge when the grinding sludge is discharged is removed from the grinding sludge and can be returned to the separation process. The mechanical expression of the separating agent out of the grinding sludge ensures that grinding sludge which is largely cleansed and is freed of grinding oil and separating agent can be delivered again to the smelting process without problems.

The ratio of the grinding sludge fed into the stirred tank to the further separating agent is preferably set to a predetermined value, and both are introduced by metering into the stirred tank according to this ratio.

The de-oiled grinding sludge is preferably pumped out of the stirred tank. The grinding sludge which still contains separating agent proceeds into a separate tank, in which for example a screen can be disposed, through which the separating agent can be removed from the grinding sludge by draining.

In most cases it is sufficient for the steps of stirring and stoppage to be carried out once. However, depending upon consistency and constituents of the grinding sludge and the grinding oil used it may be quite sensible to repeat the steps of stirring and stoppage at least once, in order to ensure a cleansing of the grinding oil out of the grinding sludge to the necessary extent, so that this residual oil content is clearly below 3%.

The removed grinding oil is preferably pumped out, drawn off or pressed out of the stirred tank through the passage in the annular plate into the closed discharge conduit for grinding oil for direct re-used. In this case the annular plate is lowered to the in order to the level of the mixture in the stirred tank which is reduced by the volume of the grinding oil pumped out or drawn off, so that the annular plate covers the mixture in the stirred tank at the top substantially without an empty space.

### BRIEF DESCRIPTION OF THE DRAWINGS

Further advantages and details of embodiments of the apparatus according to the disclosure as well as the method according to the disclosure are clear from the detailed description of the attached drawings. In the drawings:

FIG. 1 shows a complete plant module according to the disclosure, consisting of the stirred tank with an annular plate, external grinding oil tank, external separating agent tank and external de-oiled grinding oil tank with different vertical settings of the annular plate;

FIG. 2A shows the stirred tank filled with a mixture of separating agent and grinding sludge with a stirrer disposed in the lower region and an annular plate covering the mixture in the upper part of the tank;

FIG. 2B shows this stirred tank according to FIG. 2A with stirrer moved upwards into the region of the annular plate;

FIG. 3 shows the stirred tank with a by comparison with the FIGS. 2A and 2B smaller filling level of the mixture of separating agent and grinding sludge after discharge or during discharge of the grinding oil;

FIG. 4 shows a stirred tank substantially emptied of separating agent and grinding oil with a stirrer and annular plate in the lower region of the stirred tank; and

FIG. 5 shows a separating plant constructed for a higher throughput from three stirred tanks.

### DETAILED DESCRIPTION

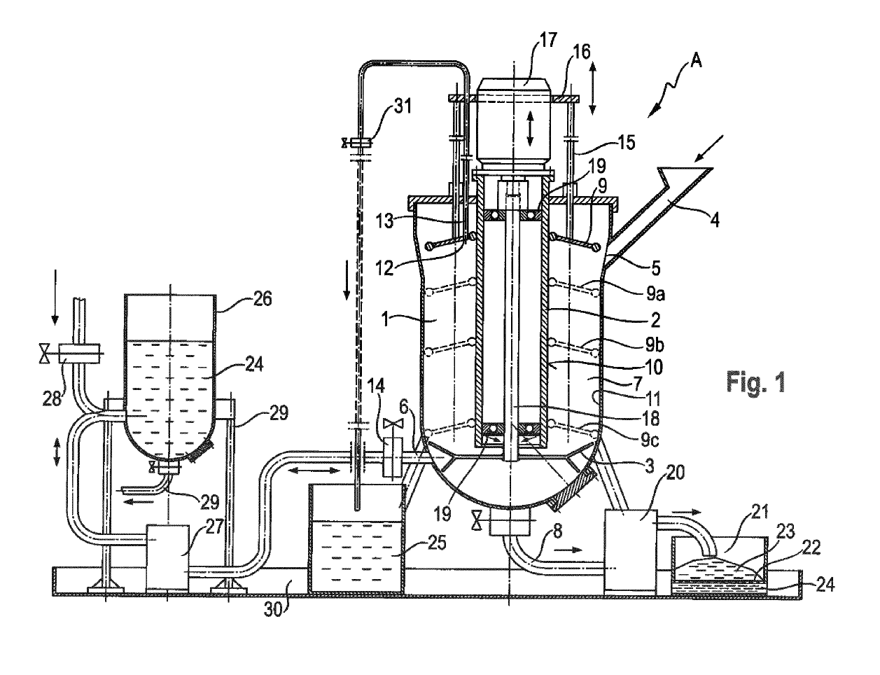

In FIG. 1 a complete apparatus for separating off grinding oil from grinding sludge is illustrated. The main part of the apparatus is the stirred tank 1, in which a stirrer guide tube 2 accommodates a shaft 18 of a stirrer 3, so that the stirrer 3 is kept stable. A drive motor 17 by which the stirrer 3 can be set in rotation is installed outside the stirred tank 1 on the upper end of the stirrer guide tube 2. This motor is speed-controlled and can be operated in both directions of rotation, so that the stirrer can be operated in rotation both in a clockwise and an anticlockwise direction. The speed at which the stirrer 3 operates is defined by the consistency of the grinding sludge to be cleansed of grinding oil and of the separating agent likewise present with the grinding sludge in the stirred tank 1. The component consisting of the stirrer guide tube 2, stirrer 3 and motor 17 is movable upwards and downwards in a controlled manner within the stirred tank 1. In the upper, somewhat widened region of the stirred tank 1 a supply conduit 4 for oil-containing grinding sludge is connected by means of a delivery opening 5 to the stirred tank 1. For simpler introduction of the grinding sludge, this supply conduit 4 widens in a funnel shape to receive the grinding sludge. In the lower region of the stirred tank 1 a supply and discharge conduit 6 for separating agent 24 is provided, which can be shut off by means of a valve 14 for this supply and discharge conduit and leads to a separating agent pump 27, by means of which the separating agent discharged or supplied by means of the supply and discharge conduit 6 for separating agent is fed to the separating agent 24 in the separating agent tank. Fresh separating agent is fed to the separating agent tank 26 by means of an undesignated supply conduit which can be closed or opened by means of a valve 28 for delivery of fresh separating agent. On the base of the separating agent tank 26 a separating agent outlet conduit 29 is connected by means of an undesignated valve.

In the lower region of the stirred tank 1, namely at the lowest point thereof, a discharge conduit 8 for de-oiled grinding sludge 23 is provided which can be closed or opened by means of a valve which is not separately designated. The discharge conduit 8 is connected to a discharge pump 20 for the oil-depleted grinding sludge 23, by means of which the oil-depleted grinding sludge taken from the stirred tank 1 is supplied to a grinding sludge tank 21, in which the grinding sludge 23 is brought onto a separating screen which is provided in the grinding sludge tank 21 and by means of which separating agent discharged together with the de-oiled grinding sludge into the grinding sludge tank 21 can be removed from the grinding sludge 23.

An inner chamber 7, which is also designated as a treatment chamber in the stirred tank 1, is formed by the inner face 11 of the stirred tank 1 and the outer face 10 of the stirrer guide tube 2. Above the delivery opening 5 an annular plate 9 is provided which is inclined upwards from the outer wall of the stirred tank in the direction of the outer face 10 of the stirrer guide tube 2. This annular plate 9 is connected to a guide rod system 15 which is provided at least on both sides and is interconnected by means of a yoke 16 or a support. By means of the yoke 16 or a support the annular plate 9 is moved upwards and downwards in the stirred tank 1 via the guide rod system 15. In the uppermost region the annular plate 9 has a passage 12 for grinding oil which is connected to a discharge conduit 13 for this grinding oil. This discharge conduit 13 has a valve 31 outside the stirred tank 1. The discharged grinding oil 25 is discharged via the discharge conduit 13 for grinding oil and via the valve 31 into a tank which is not separately designated. In addition a pump or a different extractor device can be provided for this purpose. After the filling of the stirred tank 1 with grinding sludge and separating agent the annular plate 9 is moved towards the filling level in the stirred tank leaving a hollow space. This is shown by the position 9a of the annular plate represented by a broken line. Below this is shown a position 9b of the annular plate, likewise represented by a broken line, which shows a stirred tank partially emptied of cleansed grinding oil. Finally, a position 9c of the annular plate represented by a broken line is shown in which the annular plate is disposed at its lowest position, namely if the stirred tank 1 has been almost completely emptied of separating agent, followed by discharge of the grinding sludge present in the stirred tank 1. The stirrer 3 is connected by means of a drive shaft 18 to the motor 17 and is rotatably supported in bearings 19 provided on the upper and the lower end of the stirrer guide tube 2. For reasons of safety and compliance with the Water Resources Management Acts the entire apparatus including the containers 21, 26 for de-oiled grinding sludge, grinding oil and separating agent is disposed in a safety trough 30.

The stirred tank 1 is of substantially cylindrical construction, so that upon rotation of the stirrer 3 in the stirred tank 1 no dead space is produced and in the shortest possible time a homogeneous mixture of grinding sludge and separating agent is produced, so that substantially all of the grinding particles are washed by separating agent, so that the grinding particles of the grinding sludge can be washed off from almost all of the grinding oil. Thus the stirred tank 1 in conjunction with the stirrer 3 is configured so that a homogeneous mixture of separating agent and grinding sludge can be achieved in a reasonably short time, without the speeds of the stirrer 3 having to be very high, so that emulsification of the grinding oil in the separating agent is prevented. Therefore, depending upon the requirements, the speeds of the stirrer 3 are in the range from approximately 100 to 1000 min⁻¹. The cylindrical tank has a diameter of preferably 500 to 700 mm and a height of preferably 1000 to 1500 mm, wherein, depending upon the amount of grinding sludge to be cleaned, the separating agent used and further factors, different dimensions could be envisaged.

The different positions of the annular plate 9, 9a, 9b and 9c which are indicated in FIG. 1 correspond to the following functions to be carried out:

When the annular plate 9 is located in its uppermost position represented by solid lines, i.e. it is disposed above the delivery opening 5 of the supply conduit 4 for oil-containing grinding sludge, the tanks is charged with grinding sludge and separating agent.

After the charging of the stirred tank 1 is completed, the annular plate 9 is moved downwards into the region below the delivery opening 5 for the grinding sludge onto the surface of the mixture of grinding sludge and separating agent into a region of the stirred tank in which a cylindrical wall is provided, so that the annular plate 9 forms a seal on the inner face 11 of the stirred tank on the one hand and on the outer face 10 of the stirrer guide tube 2 on the other hand. In this position 9a the stirring takes place by rotation of the stirrer 3 with stirrer being moved simultaneously upwards and downwards if necessary.

After a substantially homogeneous mixture of grinding sludge and separating agent has been produced, a resting phase or shutdown of the stirrer 3 of preferably 5 to 10 minutes takes place, after which the grinding oil is floating on the separating agent. This is followed by expression of the grinding oil via the passage 12 in the annular plate 9 and the discharge conduit 13 for grinding oil as far as the position 9b.

After the grinding oil has been expressed in the position 9b, an expression of the separating agent and a discharge of the grinding sludge can be achieved by movement of the annular plate 9 into the position 9c.

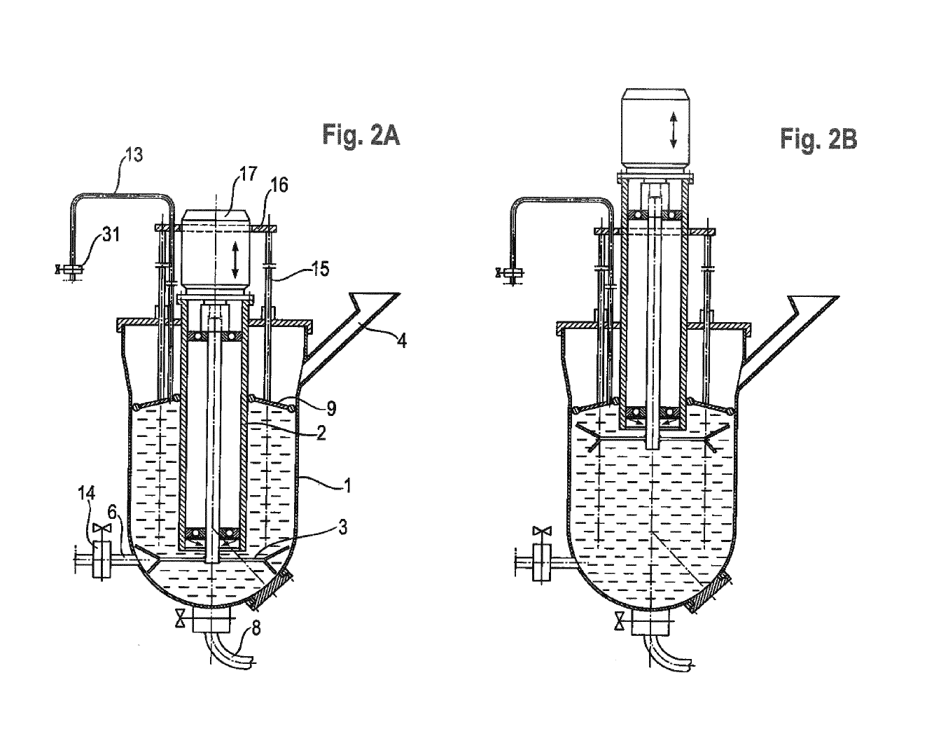

In the FIGS. 2A and 2B the parts designated in FIG. 1 have the same reference numerals, so that all the parts are not repeated here for the description of the plant. In FIG. 2A a charged state of the stirred tank 1 is shown, in which a mixture of oil-containing grinding sludge and separating agent is introduced approximately to the maximum filling level. The annular plate 9 is disposed below the delivery opening 5 for grinding sludge in a region below which the outer wall of the stirred tank 1 has a constant diameter in the downward direction. In this region the annular plate 9 is disposed so that it abuts and forms a seal both against the inner face 11 of the stirred tank and also against the outer face 10 of the stirrer guide tube 2. The annular plate 9 is disposed above the upper filling level in the stirred tank 1 with a hollow space. The stirrer 3 is disposed in the lower region of the stirred tank 1.

On the other hand with the same filling level of the filling tank in FIG. 2B the stirrer 3 is moved into its position just below the annular plate 9. Thus it is clear that in order to produce a homogeneous mixture of grinding sludge and separating agent it is sensible for the height of the stirrer 3 in the stirred tank 1 to be continuously adjusted, optionally also to be moved upwards and downwards a number of times, in order to ensure that in all regions of the mixture of separating agent and grinding sludge the mixture is as homogeneous as possible, and as far as possible the separating agent can be guided onto every individual grinding particle of the grinding sludge.

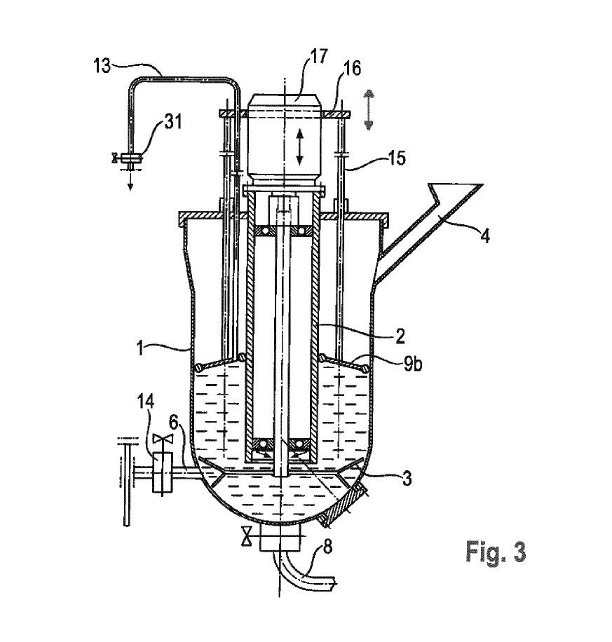

FIG. 3 shows a similar situation to that of FIG. 2A, the only difference being that the filling level in the stirred tank is lowered. Such a filling level exists for example if grinding oil 25 has been discharged via the discharge conduit 13 for the grinding oil. It can be seen from FIG. 3 that depending upon the filling level in the stirred tank 1 the annular plate 9 is always moved to the upper level of the mixture substantially without a hollow space after the stirrer has been stopped and grinding oil is floating or not yet completely discharged.

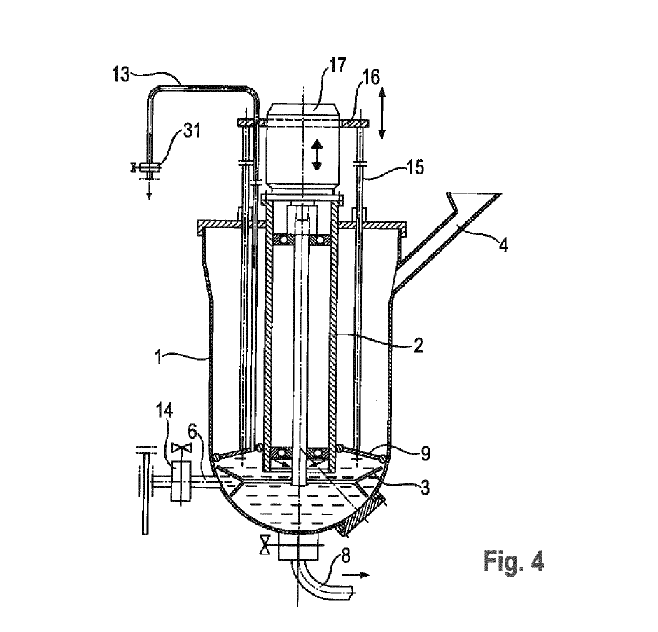

And finally, FIG. 4 shows an almost empty stirred tank 1 in which the stirrer is in its lowermost position and the annular plate 9 is moved almost to the stirrer. If the de-oiled grinding sludge has been discharged from the lowermost position in the stirred tank 1 by means of the discharge conduit 8, in the position illustrated in FIG. 4 there is substantially only separating agent still present in the stirred tank 1, which the prerequisite for providing that with a new addition of oil-containing grinding sludge via the supply conduit 4 into the stirred tank 1 this grinding sludge does not clump together on the stirrer 3.

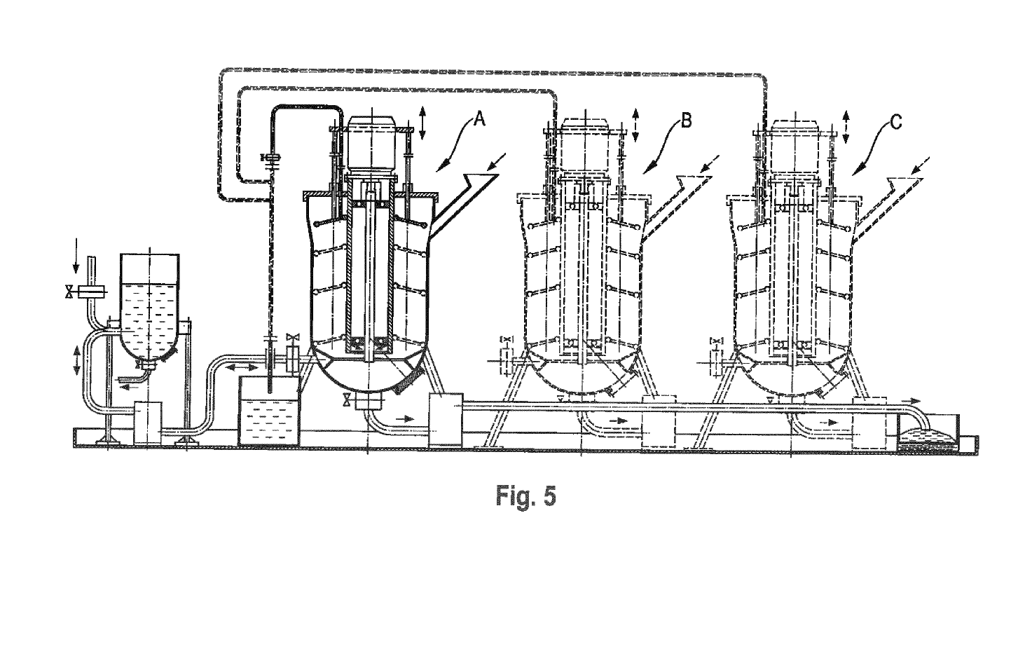

Finally, FIG. 5 shows that with required higher throughputs the modular structure of the plant can be expanded in such a way that a plurality of cleaning modules A, B, C can be combined into a plant disposed on a safety trough, wherein all of the stirred tanks of the cleaning modules can be connected in each case to correspondingly dimensioned tanks for de-oiled grinding sludge, grinding oil and separating agent.

Thus with the plant according to the disclosure it is possible, in more or less continuous operation, to remove oil from oil-containing grinding sludge up to values of grinding oil such that without further treatment the grinding oil can be supplied to a smelting process and the cleansed grinding oil can be supplied for reuse in grinding. Thus with the plant according to the disclosure there is hardly any waste oil, which considerably improves the ecological value of such a plant by comparison with the known plants.

In principle the apparatus is suitable for installation on a vehicle such as for example a lorry or another suitable transport means. However, it can also be permanently installed in a production hall in the region of the grinding machine for example, in order to unnecessary transport of the grinding sludge. The installation of mobile or stationary plants can be chosen freely because of the modular construction of the apparatus. In the case of a mobile apparatus it is for example also conceivable for the grinding sludge to be cleaned upon request made in the customer order. Likewise it is possible to set up a larger-capacity plant in a stationary manner and to transport the grinding sludge from a plurality of customers to the plant.

The modular structure of the apparatus makes it possible that for example a first expansion stage can be retrofitted later.

Depending upon the requirements, the amount of grinding sludge to be cleaned, the erection site, etc., the apparatus can be controlled manually or fully automatically.

In addition to the fact that the de-oiled grinding sludge can be delivered to a smelting process and the cleansed grinding oil can be returned directly to the grinding process, it is significant that the separating agent is preferably biodegradable.

1-19. (canceled)

20. Apparatus for separating off grinding oil (25) from grinding sludge, comprising:
a) a stirred tank (1) with a stirrer (3) which can be moved upwards and downwards in the stirred tank and is supported in a stirrer guide tube (2);
b) a supply conduit (4) for oil-containing grinding sludge disposed in the upper region of the stirred tank (1);
c) a supply and discharge conduit (6) for a separating agent (24) for separating off the grinding oil (25) from the grinding sludge and a discharge conduit (28) for de-oiled grinding sludge, which conduits are disposed in the lower region of the stirred tank (1);
d) an annular plate (9) which can move upwards and downwards in the stirred tank (1) between a region above a delivery opening (5) of the supply conduit (4) for the oil-containing grinding sludge and a region above the supply and discharge conduit (6) for the separating agent;
e) which, as it moves upwards and downwards, slides in a sealing manner on an outer face (10) of the stirrer guide tube (2) facing the inner chamber (7) of the stirred tank (1) and on the inner face (11) of the stirred tank (1) and
f) which has a passage (12) for the grinding oil (25) with a connected discharge conduit (13);
g) wherein in a first mode of operation the stirrer (3) mixes the oil-containing grinding sludge with the separating agent (24) by stirring and in a second mode of operation the stirrer remains at a standstill, wherein the grinding oil (25) floats above the separating agent (24) and can be discharged via the discharge conduit (13) from the stirred tank (1).

21. Apparatus according to claim 20, wherein the annular plate (9) is inclined upwards in the direction of the stirrer guide tube (2) and the discharge conduit (13) for the grinding oil (25) is disposed on the annular plate (9) in the region of the outer face (10) of the stirrer guide tube (2).

22. Apparatus according to claim 20, wherein, as the stirrer (3) moves upwards in the direction of the annular plate (9) the distance moved does not fall below a preselected minimum distance.

23. Apparatus according to claim 20, wherein the stirrer (3) is driven in a controlled manner in such a way that the grinding oil (25) separated off from the grinding sludge by means of the separating agent (24) is not emulsified with the separating agent (24) during stirring, and the duration of the stoppage of the stirrer (3) is such that the grinding oil (25) separated out of the grinding sludge floats with a formed separating surface on the separating agent and can be reused for grinding after removal from the stirred tank (1).

24. Apparatus according to claim 20, wherein the stirrer (3) is driven so that it is speed-controlled and the direction of rotation can be reversed.

25. Apparatus according to claim 20, wherein the stirrer (3) can be moved upwards or downwards during its first mode of operation in the stirred tank (1).

26. Apparatus according to claim 20, further comprising sensors for detecting the viscosity of the fluid in the discharge conduit (13) supply a signal when separating agent (24) enters the discharge conduit (13), and then on the basis of the signal a valve (14) in the discharge conduit (13) is closed.

27. Method for separating off grinding oil (25) from grinding sludge including grinding particles, the method comprising:
a) grinding sludge, which includes grinding oil (25), and separating agent for decreasing the surface tension of the grinding oil (25) on the grinding particles are delivered to a stirred tank (1);
b) by means of a rotationally driven stirrer (3) a substantially homogeneous mixture of grinding sludge and separating agent is produced;
c) then the stirrer (3) is stopped;
d) following which the grinding oil (25) separated out of the grinding sludge floats on the separating agent and
e) and the grinding oil (25) and the de-oiled grinding sludge (23) are discharged from the stirred tank (1).

28. Method according to claim 27, wherein a quantity of separating agent is introduced into the stirred tank (1) before grinding sludge including the grinding oil (25) is delivered to the stirred tank (1) together with further separating agent.

29. Method according to claim 27, wherein consumed separating agent in the stirred tank is discharged and a quantity of fresh separating agent (24) corresponding to the discharged quantity is returned to the stirred tank (1).

30. Method according to claim 27, wherein a quantity of separating agent discharged from the stirred tank (1) is introduced into the stirred tank through a correspondingly increased quantity of the further separating agent simultaneously with the grinding sludge.

31. Method according to claim 27, wherein an annular plate (9) covering the mixture of grinding sludge and separating agent in the stirred tank (19) is moved in a controlled manner in co-ordination with the stirrer (3) in the vertical direction of the stirred tank (1).

32. Method according to claim 27, wherein the de-oiled grinding sludge (23) is dried thermally or mechanically.

33. Method according to claim 32, wherein the mechanical drying takes place by pressing.

34. Method according to claim 27, wherein the grinding sludge and the further separating agent are introduced into the stirred tank (1) by metering in a predetermined ratio to one another.

35. Method according to claim 27, wherein the stirrer (3) is continuously variably speed-controlled.

36. Method according to claim 27, wherein the de-oiled grinding sludge (23) is pumped out of the stirred tank (1).

37. Method according to claim 27, wherein stirring and stopping the stirrer (3) are carried out at least twice.

38. Method according to claim 27, wherein the grinding oil (25) which is separated off is pumped out or drawn off from the stirred tank (1).
